(19) United States
(12) Patent Application Publication
(10) Pub. No.: US 2024/0096032 A1
(43) Pub. Date: Mar. 21, 2024

(54) TECHNOLOGY FOR REPLICATING AND/OR CONTROLLING OBJECTS IN EXTENDED REALITY

(71) Applicant: Meta Platforms Technologies, LLC, Menlo Park, CA (US)

(72) Inventors: Sean McCracken; Saransh Solanki, Seattle, WA (US)

(21) Appl. No.: 17/963,947

(22) Filed: Oct. 11, 2022

Related U.S. Application Data
(60) Provisional application No. 63/254,510, filed on Oct. 11, 2021.

(51) Int. Cl. G06T 19/00; G06F 3/04815

(52) U.S. Cl. CPC G06T 19/006; G06F 3/04815

(57) ABSTRACT

A technology to have better experiences, e.g., beyond-arm's-length experiences, with fine-tuned interactions in an extended-reality environment can include methods, extended-reality-compatible devices, and/or systems configured to generate, e.g., via an extended-reality-compatible device, a copy of a representation of an object in an extended-reality environment, to initiate control of the copy of the representation of the object according to a schema; and to control the copy of the representation of the object at a first location in the extended-reality environment, e.g., the first location including a location beyond-arm's-length distance from a second location in the extended-reality environment, the second location being a location of an avatar or representation of a user and/or a controller of the extended-reality-compatible device.

### CROSS-REFERENCE TO RELATED APPLICATIONS

This application is a non-provisional of, and claims priority to and the benefit of, U.S. Provisional Patent Application Ser. No. 63/254,510, filed Oct. 11, 2021, and entitled “Technology for Replicating and/or Controlling Objects in Extended Reality,” the entirety of which is incorporated herein by reference.

### BACKGROUND

In extended reality, reaching and interacting with items beyond arm's reach is cognitively costly. It previously required users to virtually walk to or teleport to the location, which takes time, takes recalibration, and takes the user out of their contextual experience. Simply stretching arms to the location introduces too much distortion and loses the ability to have fine interactions.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which techniques for replicating and/or controlling objects in an extended-reality environment can be implemented.

FIG. 2 is a block diagram depicting an example computing device configured to participate in replicating and/or controlling objects in an extended-reality environment.

FIG. 3 illustrates an example use of the technology described herein to extend a hand clone using the technology.

FIG. 4 illustrates an example of the technology described herein to control multiple hand clones in an extended reality environment.

FIG. 5(A) illustrates an example of the technology described herein to control multiple hand clones in an extended reality environment.

FIG. 5(B) illustrates an example of the technology described herein to control multiple hand clones in an extended reality environment.

FIG. 6(A) illustrates an example of the technology described herein to control one or more camera clones in an extended reality environment.

FIG. 6B illustrates an example of the technology described herein to control multiple camera clones in an extended reality environment.

FIG. 6C illustrates an example of the technology described herein to control multiple types of clones in an extended reality environment.

FIG. 7 is a flowchart illustrating an example process employing the technology described herein.

### DESCRIPTION

This application is directed to a technology to have better experiences, e.g., beyond-arm's-length experiences, with fine-tuned interactions in an extended-reality (ER) environment. Various aspects of the technology are described further below in text and via accompanying images and drawings. The images and drawings are merely examples and should not be construed to limit the scope of the description or claims. For example, while examples are illustrated in the context of a user interface for an ER-compatible device, the techniques can be implemented in 2D and/or 3D, and using any computing device. The user interface can be adapted to the size, shape, and configuration of the particular computing device.

This application describes techniques and features for replicating and controlling objects beyond arms-length in an ER environment. As used herein, the terms “virtual environment,” “extended-reality environment” or “ER environment” refer to a simulated environment in which users can fully or partially immerse themselves. For example, an ER environment can comprise virtual reality, augmented reality, mixed reality, etc. An ER environment can include virtual representations of objects and physical items with which a user can interact. In many cases, a user participates in an ER environment using a computing device, such as a dedicated ER device. As used herein, the terms “extended-reality device” or “ER device” refer to a computing device having ER capabilities and/or features. In particular, an ER device can refer to a computing device that can display an extended-reality user interface—in some examples, an audio and/or a graphical user interface. An ER device can further display one or more visual elements within the extended-reality user interface and receive user input that targets those visual elements. For example, an ER device can include, but is not limited to, a virtual-reality (VR) device, an augmented-reality (AR) device, and/or a mixed-reality (MR) device. In particular, an ER device can include any device capable of presenting a full and/or partial extended-reality environment. Nonlimiting examples of extended-reality devices can be found throughout this application.

In various examples, an extended-reality system can provide a representation of ER content (e.g., VR content, AR content, MR content, etc.) to a computing device, such as an ER-compatible computing device. In some examples, the ER system can include and/or be implemented by an ER-compatible computing device. The techniques described herein involve making clones, copies, or instances of one or more objects, e.g., the user of an ER-compatible device's hands and/or other body parts or whole body. The techniques may additionally or alternatively involve making clones, copies, or instances of cameras to enable users to establish multiple different points of view or perspectives within an extended reality environment. The clones, copies, or instances of the object(s) and/or camera(s) that can be cast beyond arm's length in the ER environment, making clones, copies, or instances at another location, and/or making clones, copies, or instances that can be virtually left at different locations, like by a bookshelf, a white board, a desk, a game space, a social space, etc. so that the user can simply switch focus to interact with that location without needing to physically move to that location. This provides a new framework for being able to control objects and items in ER.

In some examples, the ER content includes computer-generated content configured to be presented in association with an ER environment such as at least one of a VR environment, an AR environment, and/or an MR environment. The technology provides an enhanced experience in ER for interacting with objects and items near and far, including those that are near for rapid context switching and/or those that are more than arm's length from where the user is positioned.

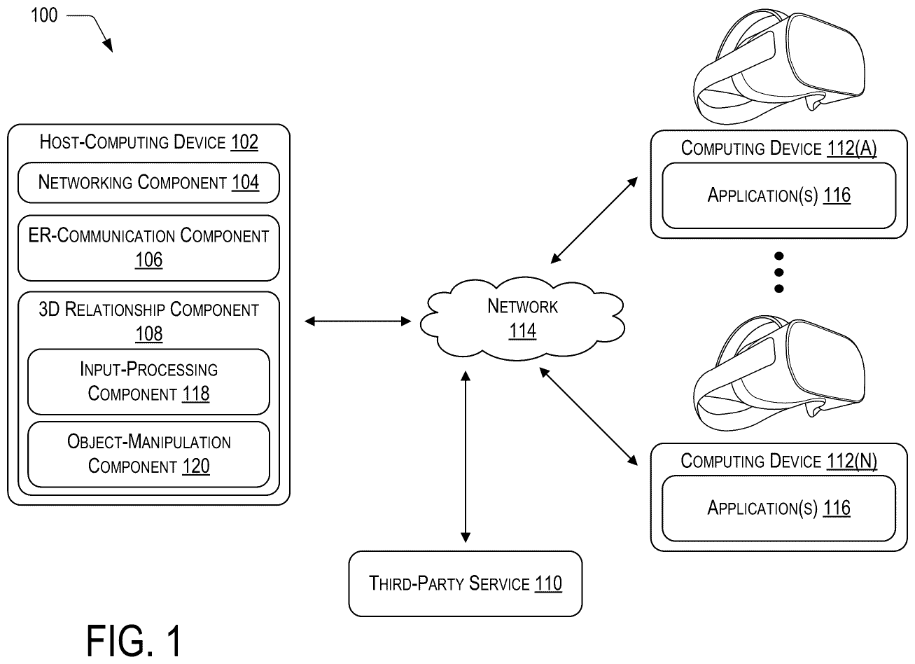

FIG. 1 is a schematic view of an example system 100 usable to implement example techniques for replicating and/or controlling objects in an environment based on input via the system 100. The example system 100 includes a host-computing device 102 that includes a networking component 104, an ER-communication component 106, and a three-dimensional (3D) relationship component 108. The system 100 can include a third-party service 110, and computing devices, e.g., ER-compatible computing devices 112(A), . . . 112(N) (collectively “computing devices 112”). In this example, A and N are non-zero integers greater than or equal to 1.

The host-computing device 102, the third-party service 110, and the computing device(s) 112 are communicatively coupled to one another via a network 114. The network 114 can be representative of any one or more communication networks, including fiber optic, cable, public switched telephone, cellular, satellite, wide area, local area, personal area, and/or any other wired and/or wireless networks. Although the system 100 of FIG. 1 is depicted as having a particular number of components, the system 100 can have any number of additional or alternative components (e.g., any number of host computing devices, client devices, third-party services, and/or other components in communication with one another via one or more networks). Any or all of the components (e.g., the host computing devices, the third-party services, and/or the computing devices 112) can include one or more processors and memory storing computer executable instructions to implement the functionality discussed herein attributable to the various computing devices.

In some examples, the system 100 can facilitate communication between users via an extended reality environment (e.g., virtual reality, mixed reality, augmented reality, or other computer-generated environment). For example, the computing devices 112 can include one or more display devices (e.g., display screens, projectors, lenses, head-up displays, etc.) capable of providing an extended reality display. By way of example and not limitation, computing devices 112, including ER-compatible devices, can include wearable computing devices (e.g., headsets, glasses, helmets, or other head-mounted displays, suits, gloves, watches, etc.), handheld computing devices (e.g., tablets, phones, handheld gaming devices, etc.), portable computing devices (e.g., laptops), or stationary computing devices (e.g., desktop computers, televisions, set top boxes, vehicle display, head-up display, etc.). The computing devices 112 can be implemented as standalone computing devices comprising substantially all functionality in a single device, or can be coupled via wired or wireless connection to one or more other computing devices (e.g., PCs, servers, gateway devices, coprocessors, etc.), peripheral devices, and/or input/output devices.

The computing devices 112 can store and/or execute one or more applications 116, such as operating systems, a web browser, or other native or third-party applications (e.g., social media applications, messaging applications, email applications, productivity applications, games, etc.). The applications 116 can execute locally at the computing devices 112 and/or can communicate with one or more other applications, services, or devices over the network 114. For instance, the computing devices 112 can execute one or more of the applications 116 to interface with the networking component 104, the extended reality communication component 106, and/or the 3D relationship component 108 of the host computing device 102. Additionally or alternatively, the computing devices 112 can execute one or more of the applications 116 to interface with functionality of the third-party service 110.

The host computing device 102 can generate, store, receive, and/or transmit data, such as networking data, communications data, extended reality data, and/or application data. For example, the host computing device 102 can receive user input from and/or output data to one or more of the computing devices 112. As shown in FIG. 1, the host computing device 102 includes a networking component 104. In some examples, the networking component 104 can provide a digital platform that includes functionality through which users of the networking component 104 can connect to and/or interact with one another. For example, the networking component 104 can register a user (e.g., a user of one of the computing devices 112) to create an account for the user. The networking component 104 can, with input from a user, create and store a user profile associated with the user. The user profile can include demographic information, communication channel information, and information on personal interests of the user. The user profile information can additionally or alternatively include, for example, biographic information, demographic information, behavioral information, the social information, or other types of descriptive information, such as work experience, educational history, hobbies or preferences, interests, affinities, or location. Interest information can include interests related to one or more categories, which can be general or specific. As an example, if a user “likes” an article about a brand of shoes, the category can be the brand.

The networking component 104 can further provide features through which the user can connect to and/or interact with other users. For example, the networking component 104 can provide messaging features and/or chat features through which a user can communicate with one or more other users. The networking component 104 can also generate and provide groups and communities through which the user can associate with other users.

Authorization services can be used to provide and enforce one or more privacy settings of the users of the networking component 104. A privacy setting of a user determines how particular information associated with a user can be shared. The authorization services can allow users to opt in to or opt out of having their actions logged by the networking component 104 or shared with other applications (e.g., extended reality communication component 106, 3D relationship component 108, applications 116) or devices (e.g., the third-party service 110), such as, for example, by setting appropriate privacy settings.

In some examples, networking component 104 comprises a social networking service (such as but not limited to Facebook™, Instagram™, Snapchat™, Linkedln™, etc.). Alternatively or additionally, the networking component 104 can comprise another type of system, including but not limited to an e-mail system, search engine system, e-commerce system, gaming system, banking system, payment system, or any number of other system types with which users have accounts. In examples in which the networking component 104 comprises a social networking system, the networking component 104 can include a social graph system for representing and analyzing a plurality of users and concepts. A node storage of the social graph system can store node information comprising nodes for users, nodes for concepts, and nodes for items. An edge storage of the social graph system can store edge information comprising relationships between nodes and/or actions occurring within the social networking system.

The host computing device 102 in this example includes the extended reality communication component 106. In some examples, the extended reality communication component 106 utilizes the host computing device 102 to enable users to communicate with one another in an extended reality communication session. For example, the extended reality communication component 106 can utilize the host computing device to receive user input corresponding to a particular co-user and send an invitation to join an extended reality communication session to an extended reality device corresponding to the co-user.

For example, the extended reality communication component 106, via host computing device 102, generates an extended reality lobby user interface element, e.g., a graphical user interface element for display on an extended reality device (e.g., one of the computing devices 112) associated with a user of a networking system. The extended reality communication component 106 further, via host computing device 102, determines a connection (e.g., on the social graph) between the user and a co-user. Based on the connection, the extended reality communication component 106 provides a computer-generated visual representation (e.g., avatar) of the co-user for display within the extended reality lobby visible via the extended reality lobby user interface element, e.g., a graphical user interface element displayed on the extended reality device associated with the user. Via the host computing device 102, the extended reality communication component 106 receives user input targeting the computer-generated visual representation of the co-user and generates and sends an invitation to join an extended reality communication session for display on an extended reality device associated with the co-user.

The host computing device 102 in this example includes the 3D relationship component 108. The 3D relationship component 108 in the illustrated example includes an input-processing component 118 and an item-manipulation component 120. In some examples, the 3D relationship component 108 receives an input from one of the computing devices 112, and generates a 3D visual representation of a relationship in an extended reality environment based at least in part on the input by leveraging various functionality described below of the input-processing component 118 and the item-manipulation component 120. Examples herein may refer to an input received by the 3D relationship component 108 and/or the input-processing component 118 as a speech input, other types of inputs are supported as well, including as gaze tracking, head position, gesture inputs, controller inputs, and other forms of input as further mentioned herein. In some instances, different and/or multiple inputs can be interpreted by the 3D relationship component in tandem with one another to discern meaning of the multiple inputs, such as by associating a path of a gaze of a user of the computing device 112(A), a path of a pose (e.g., as indicated by pointing with or without a handheld controller), and/or a speech input. Other combinations of different and/or multiple inputs are also considered.

For example, the input-processing component 118 can receive an input from a computing device 112(A) via the network 114. For instance, the computing device 112(A) can include one or more cameras and/or microphones that capture images and/or sound in an environment surrounding the computing device 112(A). The computing device 112(A) can transmit a signal corresponding to the images and/or sound captured by the camera(s) and/or microphone(s) to the input-processing component 118. In examples, the input-processing component 118 can determine that the image and/or sound represented by the signal includes gestures and/or speech. Gesture(s) detected from such a signal is referred to herein as “gesture input,” and speech detected from such a signal is referred to herein as a “speech input.”

In some instances, the input-processing component 118 determines a semantic meaning from input. To determine the semantic meaning, the input-processing component 118 can leverage one or more machine-learned models. For instance, the input-processing component 118 can input the input (and/or a transcription thereof) into a deep neural network, where the deep neural network is trained to determine a semantic meaning of the input. In some cases, the deep neural network can also determine a context of multiple inputs, such as during a conversation between users of multiple of the computing devices 112 during a shared ER session.

In some scenarios, the input-processing component 118 can “learn” the semantic meaning of new inputs, e.g., gestures, words, or phrases, by tracking actions taken by user(s) of the computing device(s) 112 in an ER environment over time. In an illustrative example, a user of the computing device 112(A) can provide a speech input that includes “bring me the book Gulliver's Travels from the library,” and a copy of a graphical representation of an object associated with a user of the computing device 112(N) can select the book “Gulliver's Travels” from the library and move the book to the user of the computing device 112(A). If input-processing component 118 does not have a previous semantic meaning for “the book Gulliver's Travels,” (and/or has a different semantic meaning for “the book Gulliver's Travels” than the item that was passed), the input-processing component 118 can assign the term “the book Gulliver's Travels” to the item that was passed. When the term “the book Gulliver's Travels” is used in future ER sessions, the input-processing component 118 can rely on this semantic meaning associated with the item to search for the same or similar items that are being referenced in the ER environment.

A similar technique can be employed by the input-processing system 118 for action terms (e.g., verbs) provided by a user of any of the computing devices 112 and previously unknown to the input-processing component 118 as well. For example, the user of the computing device 112(A) can provide an input to “open the book,” and the copy of a graphical representation of the object can perform the action of opening the book. As another example, the user of the computing device 112(A) can provide an input to “bring me the book,” and the copy of a graphical representation of the object can perform the action such as by moving the moving the book from the library to the user in the extended reality environment. Other examples are also considered of functionality employed by the input-processing component 118 to determine a semantic meaning of the input.

In some examples, the input-processing component 118 determines whether the input corresponds to manipulating one or more objects in an ER environment, whether the input corresponds to creation or modification of a mind map in the ER environment, and/or navigation or modification of a timeline of an ER session, among other examples. For example, the input-processing component 118 can determine that an input corresponds to modifying a mind map based on a determination that the computing device 112(A) is utilizing an application 116 for brainstorming. In another example, input-processing component 118 can determine that an input corresponds to adding another copy of a graphical representation of an object and/or a copy of a graphical representation of another object and/or an item to an ER environment based on a determination that the computing device 112(A) is utilizing an application 116 that for which one or more additional clones, copies, or instances and/or items would be desirable in the extended reality environment.

Based on the semantic meaning, and in some cases a determination of the application 116 being executed by the computing device 112(A) when the input was received, the input-processing component 118 can determine terms from the input that represent a relationship. For instance, in the case of the computing device 112(A) executing a brainstorming application, the input-processing component 118 can determine relationships between concepts to be included in a mind map. To illustrate, the input-processing component 118 can receive a speech input that includes “Let's talk about the size and shape of the new widget.” In response, the input-processing component 118 can determine that “widget” is a concept of a mind map during a brainstorming session, and “size” and “shape” are sub-concepts related to the “widget” concept.

In examples, the input-processing component 118 can provides the terms to the item-manipulation component 120 to automatically generate a 3D visual representation of the relationship between the terms. For instance, the item-manipulation component 120 can receive an indication of an object in an extended reality environment as a first term, and an action to manipulate the object as a second term. Based on the first term and the second term, the item-manipulation component 120 can generate the representation of the action to be performed relative to the item in three dimensions in the extended reality environment. In an illustrative example, a speech input can include “Put a hat on the avatar,” where the terms provided by the input-processing component 118 to the object manipulation component 116 are “put,” “hat,” and “avatar.” The item manipulation component 116 can generate a 3D representation of the terms by selecting a VR hat object from an object library (not pictured) of the host computing device 102, and causing the VR hat object to appear on an avatar in an ER environment being presented to a user via the computing device 112(A).

The 3D relationship component 108 (and the components associated therewith) can be configured to visually represent relationships based on speech inputs from a single user or multiple users. For example, the input-processing component 118 can receive a first input from a first user of the computing device 112(A) in an ER environment. Based on this first input and terms extracted by the input-processing component 118, the item-manipulation component 120 can cause a first object to perform an action associated with the item and present a view of the action to the first user via the computing device 112(A) and a second user of the computing device 112(N) who is also present in the ER environment, although the second user can be in a different physical location than the first user. The input-processing component 118 can then receive a second input from the second user to interact with the item. The input-processing component 118 can determine a second semantic meaning of the second input using the techniques described herein. The input-processing component 118 can provide the terms from the semantic meaning to the item-manipulation component 120 can cause a second object to perform an action associated with the item and present a view of the action to the first user via the computing device 112(A) and a second user of the computing device 112(N). In this way, multiple users can leverage the capabilities of the 3D relationship component to collaboratively create visual relationships in ER environments.

While the 3D relationship component 108, the input-processing component 118 and the item-manipulation component 120 are shown in this example as separate components of the host computing device 102, in other examples, any of these components can be a sub-component or feature of the ER-communication component 106, the computing devices 112, the third-party service 110, or another device not pictured in the system 100.

In some examples, the third-party service 110 stores and/or provides access to various third-party sources of digital data. For example, the third-party service 110 can be accessed by the host-computing device 102 and/or the computing devices 112 to provide functionality by which the host-computing device 102 and/or computing devices 112 can generate, access, view, search for, and/or interact with digital data. In some instances, the third-party service 110 includes a database storing digital files (e.g., digital documents, digital images, digital videos, etc.). In some examples, the third-party service 110 includes a search engine that provides search results in response to receiving a search query, another social networking service, a gaming service, an e-commerce marketplace, a payment service, a banking service, a remote digital storage service, a cloud computing service, or any other third-party platform hosting one or more services that are accessibly by the host computing device 102 and/or computing devices 112 via the network 114.

The networking component 104, the ER-communication component 106, and/or the 3D relationship component 108 can be implemented and/or hosted by any one or combination of computing devices of the system 100. For example, while FIG. 1 illustrates the networking component 104, the extended reality communication component 106, and/or the 3D relationship component 108 being implemented by the host computing device 102, any or all of these components can be implemented in whole or in part by a different computing device (e.g., one or more of the computing devices 112, the third-party service 110, or any combination thereof). For instance, the networking component 104, the extended reality communication component 106, and/or the 3D relationship component 108 can be implemented or hosted in a distributed computing arrangement with portions of the respective component(s) being executed on multiple different computing devices.

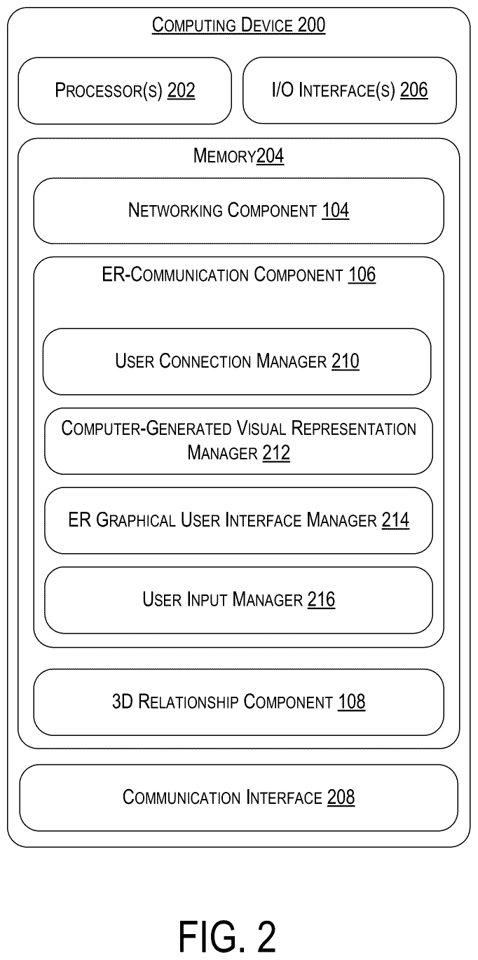

FIG. 2 illustrates an example computing device 200 usable to implement techniques such as those described herein. The computing device 200 can be representative of the host computing device 102, the third-party services 110, and/or the computing devices 112. As shown, the computing device 200 includes one or more processors 202, memory 204, input/output interfaces 206 (or “I/O interfaces 206”), and a communication interface 208, which can be communicatively coupled to one another by way of a communication infrastructure (e.g., a bus, traces, wires, etc.). While the computing device 200 is shown in FIG. 2 having a particular configuration, the components illustrated in FIG. 2 are not intended to be limiting. The various components can be rearranged, combined, and/or omitted depending on the requirements for a particular application or function. Additional or alternative components can be used in other examples.

In some examples, the processor(s) 202 can include hardware for executing instructions, such as those making up a computer program or application. For example, to execute instructions, the processor(s) 202 can retrieve (or fetch) the instructions from an internal register, an internal cache, the memory 204, or other computer-readable media, and can decode and execute them. Executing the instructions can configure a computing device, including, for example, an ER device, to perform operations as described herein. By way of example and not limitation, the processor(s) 202 can comprise one or more central processing units (CPUs), graphics processing units (GPUs), holographic processing units, microprocessors, microcontrollers, integrated circuits, programmable gate arrays, or other hardware components usable to execute instructions.

The memory 204 is an example of a hardware-type (in contrast to a signal type) of computer-readable media and is communicatively coupled to the processor(s) 202 for storing data, metadata, and programs for execution by the processor(s) 202. In some examples, the memory 204 can constitute non-transitory computer-readable media such as one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 204 can include multiple instances of memory, and can include internal and/or distributed memory. The memory 204 can include removable and/or non-removable storage. The memory 204 can additionally or alternatively include one or more hard disk drives (HDDs), flash memory, Universal Serial Bus (USB) drives, or a combination these or other storage devices.

As shown, the computing device 200 includes one or more I/O interfaces 206, which are provided to allow a user to provide input to (such as touch inputs, gesture inputs, keystrokes, voice inputs, etc.), receive output from, and otherwise transfer data to and from the computing device 200. Depending on the particular configuration and function of the computing device 200, the I/O interface(s) 206 can include one or more input interfaces such as keyboards or keypads, mice, styluses, touch screens, cameras, microphones, accelerometers, gyroscopes, inertial measurement units, optical scanners, other sensors, controllers (e.g., handheld controllers, remote controls, gaming controllers, etc.), network interfaces, modems, other known I/O devices or a combination of such I/O interface(s) 206. Touch screens, when included, can be activated with a stylus, finger, thumb, or other object. The I/O interface(s) 206 can also include one or more output interfaces for presenting output to a user, including, but not limited to, a graphics engine, a display (e.g., a display screen, projector, holographic display, etc.), one or more output drivers (e.g., display drivers), one or more audio speakers, and one or more audio drivers. In certain examples, I/O interface(s) 206 are configured to provide graphical data to a display for presentation to a user. The graphical data can be representative of one or more user interfaces, e.g., a graphical user interfaces, and/or any other graphical content as can serve a particular implementation. By way of example, the I/O interface(s) 206 can include or be included in a wearable device, such as a head-mounted display (e.g., headset, glasses, helmet, visor, etc.), a suit, gloves, a watch, or any combination of these, a handheld computing device (e.g., tablet, phone, handheld gaming device, etc.), a portable computing device (e.g., laptop), or a stationary computing device (e.g., desktop computer, television, set top box, a vehicle computing device). In some examples, the I/O interface(s) 206 can be configured to provide an extended reality environment or other computer-generated environment.

The computing device 200 also includes the communication interface 208. The communication interface 208 can include hardware, software, or both. The communication interface 208 provides one or more interfaces for physical and/or logical interfaces for communication (such as, for example, packet-based communication) between the computing device 200 and one or more other computing devices or one or more networks. As an example, and not by way of limitation, the communication interface 208 can include a network interface controller (NIC) or network adapter for communicating with an Ethernet or other wire-based network and/or a wireless NIC (WNIC) or wireless adapter for communicating with a wireless network, such as a WI-FI adapter. The communication interface 208 can additionally include a bus, which can include hardware (e.g., wires, traces, radios, etc.), software, or both that communicatively couple components of computing device 200 to each other.

FIG. 2 illustrates the networking component 104, the extended reality communication component 106, and the 3D relationship component 108 implemented by the computing device 200 (e.g., the host computing devices 102, third-party computing device, and/or one or more of the computing devices 112 as discussed above with reference to FIG. 1). As shown, the networking component 104, the extended reality communication component 106, and the 3D relationship component 108 are stored in the memory 204 of the computing device 200. Each of these components, the networking component 104, the extended reality communication component 106, and the 3D relationship component 108, can include computer-executable instructions that are executable by the one or more processors 202. While shown as separate components in this example, in other examples, the networking component 104, the extended reality communication component 106, and/or the 3D relationship component 108 can be combined with one another or grouped in other manners. For instance, in some examples, the networking component 104, the extended reality communication component 106, and the 3D relationship component 108 can all be parts of a single application or computer program. As another example, the extended reality communication component 106 can be part of the networking component 104, and/or the 3D relationship component 108 can be part of the extended reality communication component 106.

In the illustrated example, the extended reality communication component 106 can include a user connection manager 210, a computer-generated visual representation manager 212, an extended reality (“ER”) user interface, e.g., a graphical user interface, manager 214, and a user input manager 216. Also, while not shown, the memory 204 can store data, such as computer-generated visual representations, a social graph or other representation of user connections, user profiles, and/or task profiles associated with the extended reality communication component 106.

The user connection manager 210 can determine connections between a user of a networking component and one or more other users of the networking system. For example, the user connection manager 210 can determine a connection based on a task associated with the user and a task associated with the co-user, recent communications between the user and the co-user, and/or an organizational structure corresponding to an organization associated with the user and the co-user. In some examples, the user connections can be stored and/or represented in the form of a social graph.

The computer-generated visual representation manager 212 can identify one or more computer-generated visual representations to be displayed on an extended reality device. For example, the computer-generated visual representation manager 212 can identify animated visual representations (e.g., avatars), photographs, holograms, or other computer-generated visual representations that correspond to other users determined to have a connection with the user by the user connection manager 210. In some examples, the computer-generated visual representation manager 212 can also provide computer-generated visual representations for display within or in association with the 3D relationship component 108.

The extended reality communication component 106 further includes the extended reality user interface, e.g., a graphical user interface, manager 214, which provides visual elements for display within an extended reality user interface, e.g., a graphical user interface, displayed on an extended reality device. For example, the extended reality user interface, e.g., a graphical user interface, manager 214 can provide one or more extended reality lobby user interface, e.g., a graphical user interface, elements. Further, the extended reality user interface, e.g., a graphical user interface, manager 214 can provide one or more computer-generated visual representations selected by the computer-generated visual representation manager 212 for display within the extended reality lobby user interface, e.g., a graphical user interface, element(s). In some examples, the extended reality user interface, e.g., a graphical user interface, manager 214 can also provide visual elements for display within or in association with the 3D relationship component 108.

Additionally, the extended reality communication component 106 includes the user input manager 216, which can receive or otherwise detect user input. For example, the user input manager 216 can receive voice input, touch input, eye tracking input, gesture input (e.g., hand tracking, head tracking, body language, facial expressions, etc.), and/or input via a controller device associated with the extended reality communication component 106. In some instances, the user input manager 216 communicates the received user input with the extended reality user interface, e.g., a graphical user interface, manager 214 so that the extended reality user interface, e.g., a graphical user interface, manager 214 can change the visual elements provided for display on the extended reality device. In some examples, user input received via the user input manager 216 can also be used in association with the 3D relationship component 108.

As discussed above with reference to FIG. 1, the 3D relationship component 108 is configured to receive an input from a computing device (e.g., the computing device 102(A) of FIG. 1), and generate a visual representation of terms included in the input. For example, the input-processing component 118 of the 3D relationship component 108 determines a semantic meaning of the input and identifies terms in the input based on the semantic meaning. The input-processing component 118 can identify the terms based on parts of speech, such as nouns included in the input that can correspond to objects in an extended reality environment and verbs that can correspond to actions associated with the identified nouns. The input-processing component 118 can utilize a machine-learned model, such as a deep neural network, to determine the semantic meaning and/or to identify the terms.

Once the terms are identified, the 3D relationship component 108 can generate a 3D representation of a relationship between the terms and provide the 3D representation to a computing device for display. In some instances, the 3D relationship component 108 generates a 3D representation of a modification to an object in an extended reality environment using the object manipulation component 116.

Also, as discussed above, the memory 204 can store, among other things, computer-generated visual representations, user connections, an object library of virtual objects, and/or task profiles. In some examples, the computer-generated visual representations can include visual representations (e.g., animations, photographs, holograms, etc.) that correspond to the users of the networking component. The computer-generated visual representations can be selectable by the computer-generated visual representation manager 212 for display in association with the networking component 104, the extended reality communication component 106, the 3D relationship component 108, or any other application of the computing device 200. The user connections can store associations determined between users of the networking component 104 by the user connection manager 210. In examples, the memory 204 can store task profiles generated for the users of the networking component 104. The user connection manager 210 can utilize the stored task profiles to determine connections between users in some instances. Though not shown, the memory 204 can store various other forms of digital data such as, but not limited to, a social graph, user profiles, digital objects or messages that are passed from one user of a networking component to a co-user of the networking system, or the like.

While in this example, various components and/or managers are shown as being stored in the memory 204, it should be understood that this is but one example and that the functionality described herein as being attributable to these components and/or managers can be implemented in software, hardware, or both. For example, any or all of these components and/or managers can include one or more instructions stored on a computer-readable medium, e.g., a computer-readable storage medium such as a hardware storage device, or alternatively a computer-readable medium including a signal, and executable by processors of one or more computing devices, such as the host computing device 102, the third-party service 110, and/or one or more of the computing devices 112. When executed by the one or more processors, the computer-executable instructions of the extended reality communication component 106 can cause the computing device(s) to perform the methods described herein. Alternatively or additionally, the components and/or managers can include hardware, such as a special-purpose processing device to perform a certain function or group of functions. In some cases, the components and/or managers can include a combination of computer-executable instructions and hardware.

Furthermore, in some examples, any or all of the components and/or managers can be implemented as one or more operating systems, as one or more stand-alone applications, as one or more modules of an application, as one or more plug-ins, as one or more library functions application programming interfaces (APIs) that can be called by other applications, and/or as a cloud-computing model. In some instances, the components and/or managers of the networking component 104, the extended reality communication component 106, and/or the 3D relationship component 108 can each be implemented as a stand-alone application, such as a desktop or mobile application, as one or more web-based applications hosted on a remote server, and/or as one or more mobile device applications or “apps.”

The methods described herein are not limited to being performed using the systems and/or devices described regarding FIG. 1 and/or FIG. 2 and can be implemented using systems and devices other than those described herein.

Clones, copies, or instances of one or more objects, e.g., hands, arms, eyes, other parts up to and including the user's whole body and/or video and/or still camera(s), can be generated and/or initiated at and/or moved to a location remote from a first or primary instance of a user's avatar in the ER environment and/or kept at the remote location for later initiation and/or activation. Clones, copies, or instances can be generated and/or initiated and/or activated via voice control, e.g., a wake word; gaze control; a gesture; activation of a hardware and/or software button associated with the technology; and/or a power glove type technology; etc. The cloned element, e.g., cloned/copied/instance of hand(s) (and/or body part/body/camera) (individually and/or separately for control independently and/or in unison, and/or in an array for control in tandem), can be controlled by the user via an ER-compatible device without the user needing to move the first or primary instance of the user's avatar to the other location. One or more camera clone(s) can track the cloned hand(s) and can provide a more detailed view of the manipulation the hand(s) are performing, e.g., in a picture-in-picture presentation, separate windows, focus controlled by gesture, eye tracking, voice control, etc. In examples of arrays of clones, copies, or instances, the arrays can have different configurations, e.g., around a point, around an axis, in a line, in a grid, in a matrix, etc. Different control schemas can employ different algorithms to effect control of the clone(s) independently, in unison, and/or in tandem.

In at least one example, a user can be in a room and want to grab an item, e.g., a book, from another location in the ER environment, e.g., a shelf, that is farther away than their avatar can reach, e.g., on the other side of the room. The technology allows the user to grab the item with a cloned hand and bring it back, having fine-motor control over the representation of the cloned hand, without the distracting distortion that comes from virtually stretching arms of their primary avatar the extra distance or the cognitive load of virtually teleporting their primary avatar to the other location in order to grab the object.

In some examples, the other location can be a location that is not close enough to be visible to the user, e.g., in another room, in another building, in a vehicle, at another geographical location, anywhere in the world or ER environment.

In various examples, the technology allows the user to generate a copy aka clone aka instance of a graphical representation of their hand(s) and to cast the copy to the other location and/or to virtually teleport to another location to generate and/or initiate clone(s) at the other location. By way of example and not limitation, controlling movement of the copy to and/or at the other location can include any of voice control, gaze control, gesture—touch or non-touch akin to playing a theremin—control, joystick and/or mouse type control, activation of a hardware and/or software button associated with the technology, and/or a physical and/or virtual power glove type technology.

In at least one example, a user can be wearing a power-glove on one, a first, hand, can press a button associated with the power glove to generate a clone of their first hand, can control movement of the clone to another location by gesture—touch or non-touch akin to playing a theremin—control performed by their other, second, hand on a surface of the power glove, akin to flying a copy of their first hand like a drone. The user can perform finely tuned maneuvers with their first hand can control the clone of their first hand performing the same and/or associated finely tuned maneuvers while the clone is in transit to/from the other location and/or at the other location.

In at least one example, the technology allows the user to make one or more clones, copies, or instances of their hand(s) and keep the clones, copies, or instances at one or more other locations. For example, the technology enables the user to create a copy of a graphical representation of the hand they use to write and keep that copy at a white board such that the user can control the hand at the white board to make notes or drawings on the whiteboard while the user remains at their desk. An instruction to keep the clone(s) at the other location, akin to a pause, can be received via voice control, gaze control, a gesture, joystick and/or mouse type control, activation of a hardware and/or software button associated with the technology, and/or a power glove type technology.

In at least one example, a user can shift focus/context to cloned hand(s) that exist at another location by voice control, gaze control, a gesture, joystick and/or mouse type control, activation of a hardware and/or software button associated with the technology, and/or a power glove type technology. In some examples, the shift of focus/context can activate the clone(s) at the identified location, and once context has shifted, the user can control the clone as discussed above. In some examples the user can activate the clone(s) at the identified location after the focus/context has shifted, and once activated, the user can control the clone as discussed above.

In at least one example, one or more cloned cameras can provide different views/perspectives such as a view of a room, a view of the user's body, a view of a cloned hand from a zoomed perspective, etc. Images from the cloned camera(s) can be presented to the user in one or more of a variety of formats such as a primary presentation identified according to focus/context as discussed above, in a cycle aka carousel controlled by any of the techniques described above, and/or in a combined presentation such as picture-in-picture, panoramic, stitched, collage, etc. In some examples, a positioning of a cloned camera relative to a cloned hand (or other element) can be adjusted to enable customization of the view or perspective of the hands (e.g., to zoom in for finer work, to zoom out for a better view of surroundings, and/or to view from above, below, from a side and/or from any other vantage point).

### An Example Use Case

Brainstorming often takes place in large rooms with lots of object to encourage ideas. Users often complain about how tiring it can be to bring objects from various parts of the room and share with others. One attempt to solve this issue includes teleportation in VR. In that case, users can go to any location in the room and come back without physically moving to the far location. However easy this may seem, locomotion always leads to context change which reduces focus and derails discussions.

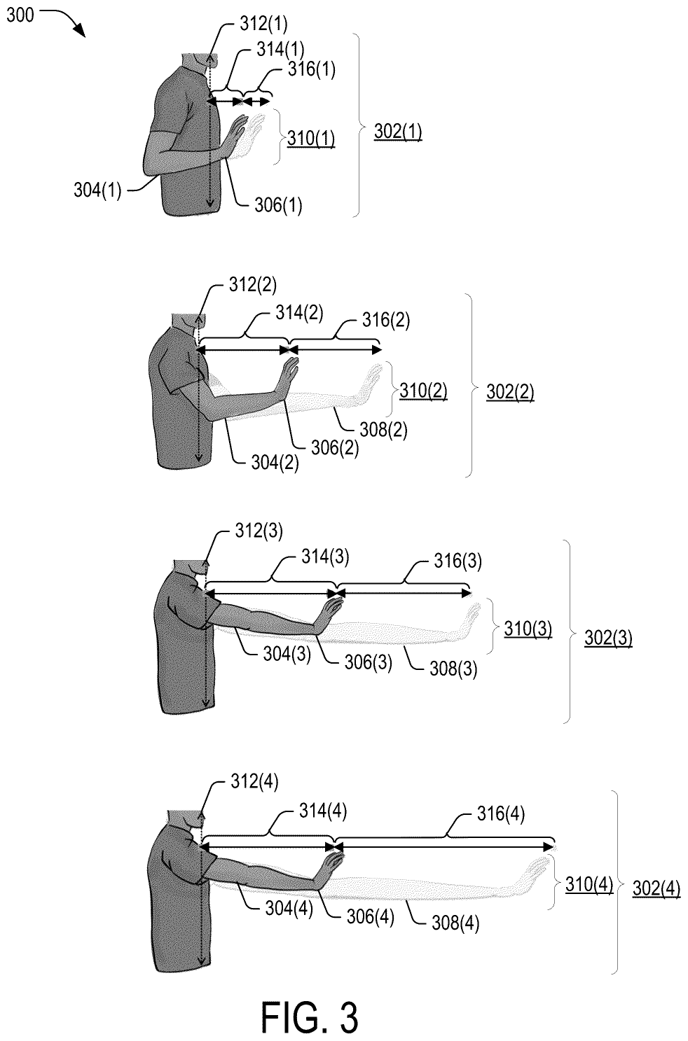

FIG. 3 illustrates an example use of the technology described herein to extend a hand using the technology, e.g., to grab a virtual object. One example use of the technology described herein is when a user wants to manipulate a virtual object at a location beyond arm's length away, e.g., bring a location closer from a location beyond arm's length away.

FIG. 3 at 300, presents a series of images 302 to describe a way that the technology can be configured so that a user can use their arm 304 and hand 306 to extend clone arm 308 and hand clone 310 using the technology to grab a virtual object. In the illustrated examples, from a starting position 312, a user extends their arm 304 and hand 306 a distance 314, and a clone arm 308 and hand clone 310 increases the reach an additional distance 316. In some examples, starting position 312 can be from the user's body, from a front vertical plane of an ER headset, etc. In various examples, distance can be calculated based on the location of an ER headset, a location of the user's body, etc. at the time the starting position 312 is determined. In various examples, as the user's arm 304 moves, a clone arm 308 can extend the hand clone 310 proportionately, e.g., by extending, stretching, elongating, etc. the clone arm 308. In some examples, a hand clone 310 can move twice the distance, or more, of the distance 314 from the user's hand 306 from the starting position 312. For example, as the user's hand 306 moves further from the starting position 312, the distance 316 the hand clone 310 moves can be increased exponentially.

In the illustrated example, at 302(1), from a starting position 312(1), a user employing the technology extends their arm 304(1) and hand 306(1) a short distance 314(1), and a cloned arm 308(1) (not shown) and hand clone 310(1) begins to increase the reach an additional distance 316(1).

In the illustrated example, at 302(2), from a starting position 312(2), which can be the same starting position as 312(1), a user employing the technology partially extends their arm 304(2) and hand 306(2), a distance 314(2), and a clone arm 308(2) and hand clone 310(2) increases the reach an additional distance 316(2).

In the illustrated example, at 302(3), from a starting position 312(3), which can be the same starting position as 312(1), 312(2), a user employing the technology extends their arm 304(3) and hand 306(3), a distance 314(3), and a clone arm 308(3) and hand clone 310(3) increases the reach an additional distance 316(3).

In the illustrated example, at 302(4), from a starting position 312(4), which can be the same starting position as 312(1), 312(2), 312(3), a user employing the technology extends their arm 304(4) and hand 306(4), a distance 314(4), and a clone arm 308(4) and hand clone 310(4) increases the reach an additional distance 316(4).

In examples, the illustrated example images 302(1), 302(2), 302(3), and 302(4), can represent the technology described herein in use during a series of points in time.

In some examples, the ratio of 2× can be used until the clone arm 308 and hand clone 310 reaches a distance 316 corresponding to the user's extended arm 304. In examples, from that point the clone arm 308 can extend, stretch, elongate, etc. in some instances, logarithmically with time, e.g., faster growth initially and slower with more time. When elongated to reach the location of the virtual object, the hand clone 310 can grasp the virtual object and the object can be carried to the user's location via a similar, though reverse process. In at least one example, inverse kinematics can be used to animate at least part of the clone arm 308 and hand clone 310.

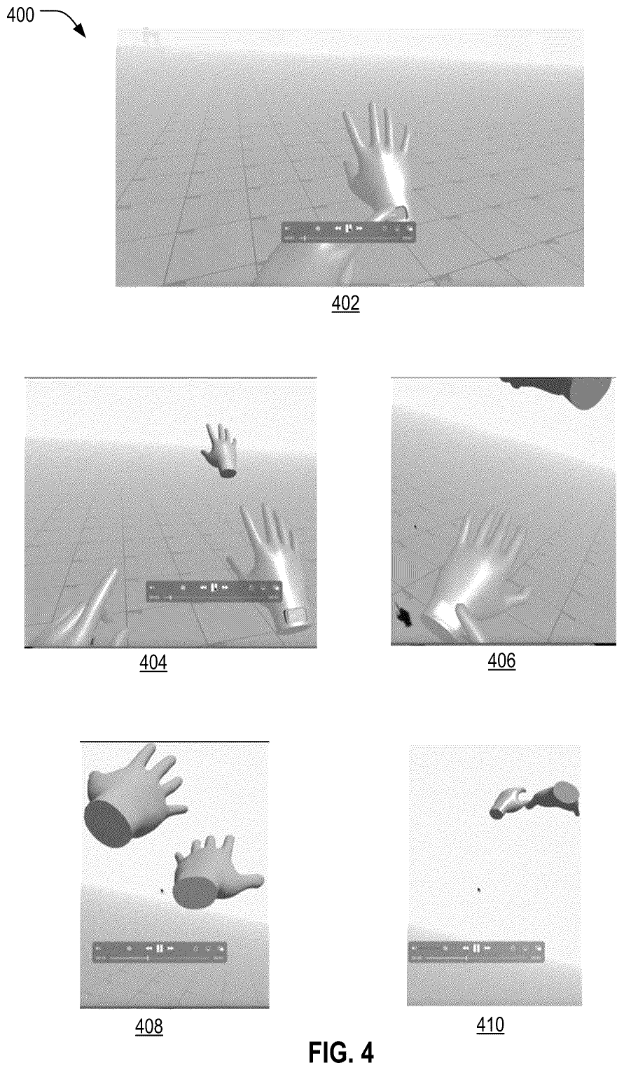

FIG. 4 illustrates an example of the technology described herein to control multiple hand clones, e.g., hand clones 310, in an extended reality (ER) environment.

FIG. 4 at 400, presents a series of images representing screen captures of recordings of prototypes of the technology described herein in use. Image 402 illustrates a clone, copy, or instance of a graphical representation of a right hand in an ER environment being created via button push on a representation of a user's right wrist. In various examples, the button can be a part of or associated with a glove (e.g., power glove), a wrist band, a virtual representation of a button associated with an ER headset, etc.

Image 404 illustrates a clone, copy, or instance of a graphical representation of the right hand in the ER environment casting away from the representation of the right hand.

Image 406 illustrates a clone, copy, or instance of a graphical representation of a left hand in an ER environment being created via button push on a representation of a user's left wrist. In various examples, the button can be a part of or associated with a glove, a wrist band, a virtual representation of a button associated with an ER headset, etc.

Image 408 illustrates a clone, copy, or instance of a graphical representation of the left hand in the ER environment casting away from the representation of the left hand with the representation of the right hand in view.

Image 410 illustrates individual clones, copies, or instances of graphical representations of both the left hand and the right hand in the ER environment being controlled independently in unison. Although a single clone, copy, or instance of a graphical representation of each of the right hand and the left hand are shown in series 400, in various examples fewer or greater clones, copies, or instances of graphical representations of either or both the left hand and the right hand can be created and used in the ER environment.

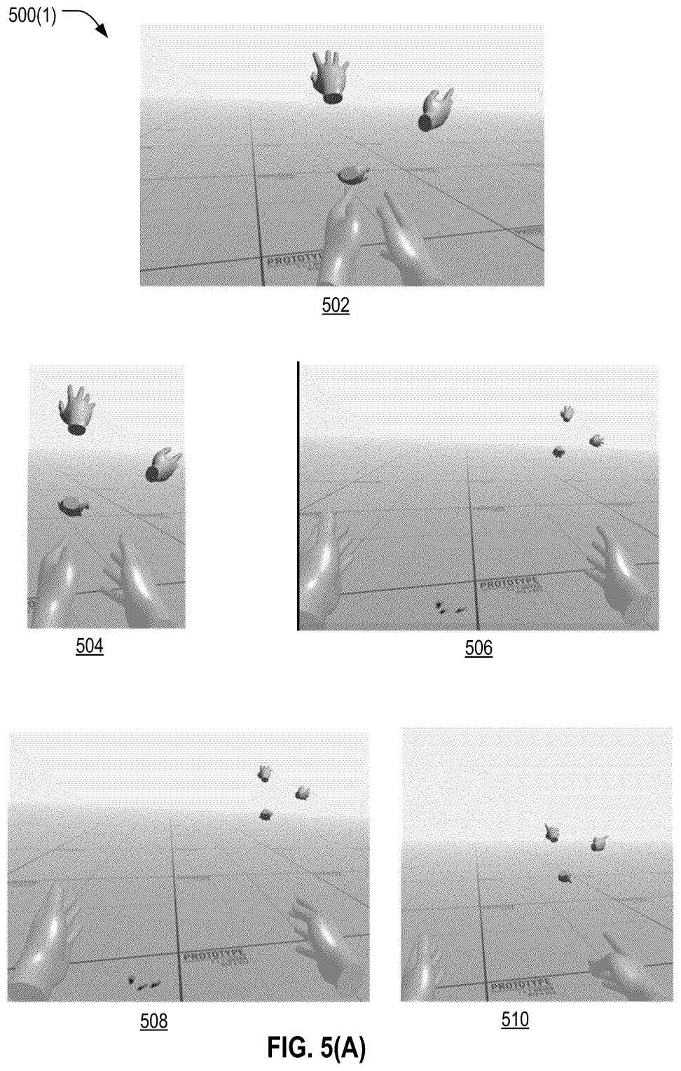

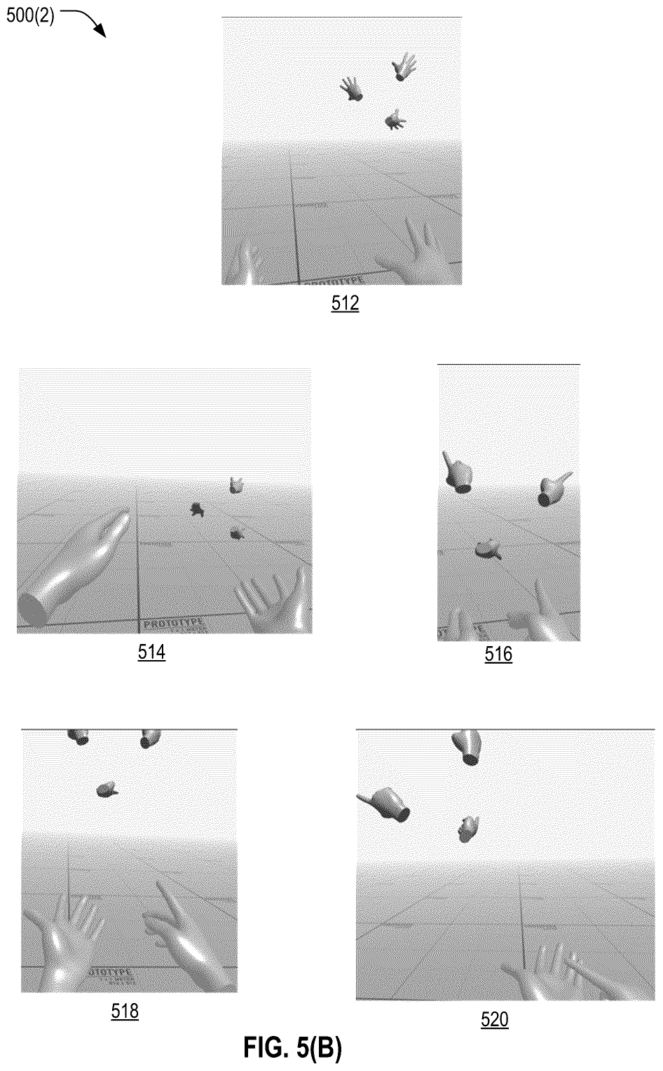

FIG. 5(A) and FIG. 5(B) illustrate an example use of the technology described herein to control graphical representations of multiple hand clones, e.g., hand clones 310, in an extended reality (ER) environment.

FIG. 5(A) at 500(1), presents a series of images representing screen captures of recordings of prototypes of the technology described herein in use.

Image 502 illustrates an array of 3 clones, copies, or instances of graphical representations of a right hand in an ER environment configured in static positions relative to each other at about 60-degrees around a central axis. In at least one example, the array can be activated by a clapping gesture of the representation of the left and right hands at the bottom of the image. An array of this configuration, which will perform the same action from different points of view, can be useful for lifting a large box or ball, for example.

Image 504 illustrates the 3 clones, copies, or instances of the graphical representations of the right hand in the ER environment configured in an array with static positions relative to each other at about 60-degrees around a central axis. In image 504, the central axis is positioned akin to an extension of the representation of the right hand.

Image 506 illustrates the same array of 3 clones, copies, or instances of the graphical representations of the right hand in the ER environment as image 504, with the representation of the right hand in a stationary position. In this example, the array is being controlled by the representation of the left hand moving/operating relative to the graphical representation of the right hand akin to playing a theremin. Image 506 shows moving the representation of the left hand farther away from the representation of the right hand on the x-axis causes the array to be moved farther away from the right hand on the z-axis. In some examples, the speed with which the representation of the left hand moves away from the representation of the right hand can control the distance the array of hands move farther away on the z-axis (e.g., on an exponential scale).

Image 508 illustrates fine control of fingers in the array in the ER environment by the representation of the right hand, and the representation of the left hand moved slightly closer to the stationary representation of the right hand on the x-axis, bringing the array closer on the z-axis. Image 508 also illustrates that rotating the right hand can rotate the array as a unit around the central axis.

Image 510 illustrates another example of fine control of fingers in the array in the ER environment by the representation of the right hand, and the representation of the left hand moved slightly closer to the stationary representation of the right hand on the x-axis, bringing the graphical representations of the array closer on the z-axis.

FIG. 5(B) at 500(2), presents a series of images representing screen captures of recordings of prototypes of the technology described herein in use. For example, series 500(2) can represent additional images from a session including the series 500(1).

Image 512 illustrates the array of 3 clones, copies, or instances of the graphical representations of the right hand in the ER environment and shows fine control of fingers of the clones, copies, or instances in the array by the representation of the right hand. Image 512 shows changing the orientation of a part of the right hand, e.g., flexing the fingers beyond full extension, such that the fingers would be pointing up if the palm were facing down, causes the array to move up on the y-axis.

Image 514 illustrates changing the orientation of the representation of the right hand in the ER environment from a palm-facing-left orientation to a palm-up orientation, which causes the graphical representations of the clones, copies, or instances in the array to make the same change in orientation of each clone. Image 514 also shows that changing the orientation of the right hand relative to the left hand causes the array to rotate clockwise around the center axis.

Image 516 illustrates fine control of fingers of clones, copies, or instances in the array in the ER environment by the representation of the right hand, and the representation of the left hand coming closer to the right hand on the x-axis causing the graphical representations of the clones, copies, or instances to come closer on the z-axis. Image 516 also shows that changing the orientation of the representation of the right hand from a palm-up orientation to a palm-facing-left orientation causes the clones, copies, or instances in the array to make the same change in orientation of each clone, copy, or instance, and changing the orientation of the representation of the right hand relative to the left hand causes the array to rotate counter-clockwise around the center axis.

Image 518 illustrates fine control of fingers of clones, copies, or instances in the array in the ER environment by the representation of the right hand, and changing the orientation of a part of the representation of the right hand, e.g., the pointer finger pointing up, causes the array to move up on the y-axis, while the representation of the left hand moving farther from the representation of the right hand on the x-axis causes the clones, copies, or instances to move farther away on the z-axis.

Image 520 illustrates that changing the orientation of a part of the representation of the right hand, e.g., the pointer finger pointing to the left over the representation of the left hand, causes the array to move left on the x-axis, and the representation of the left hand coming closer to the representation of the right hand on the x-axis causing the array of clones, copies, or instances to come closer on the z-axis.

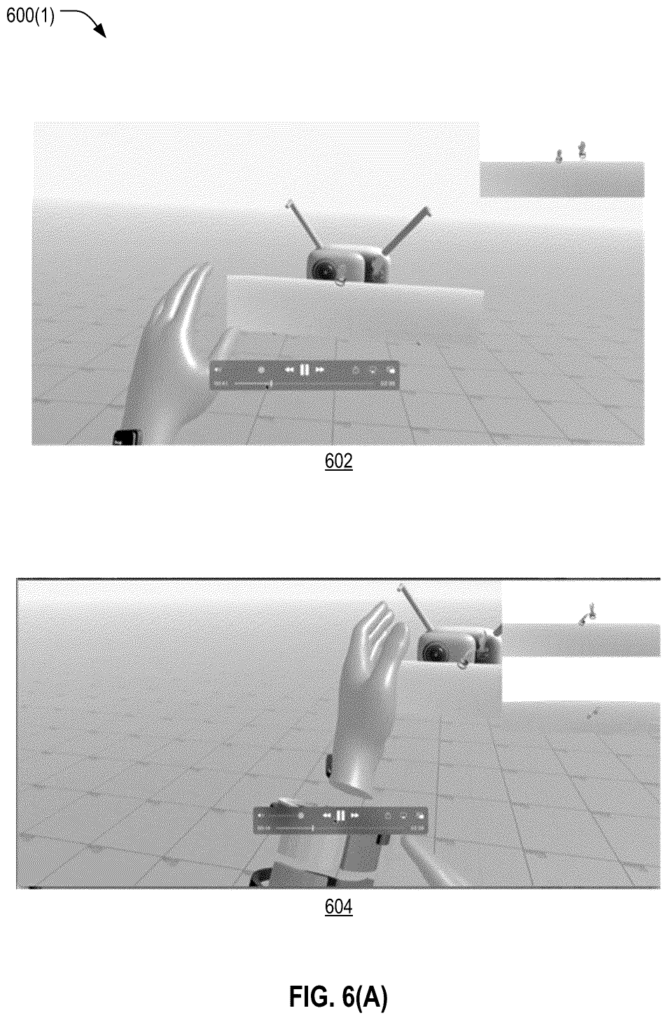

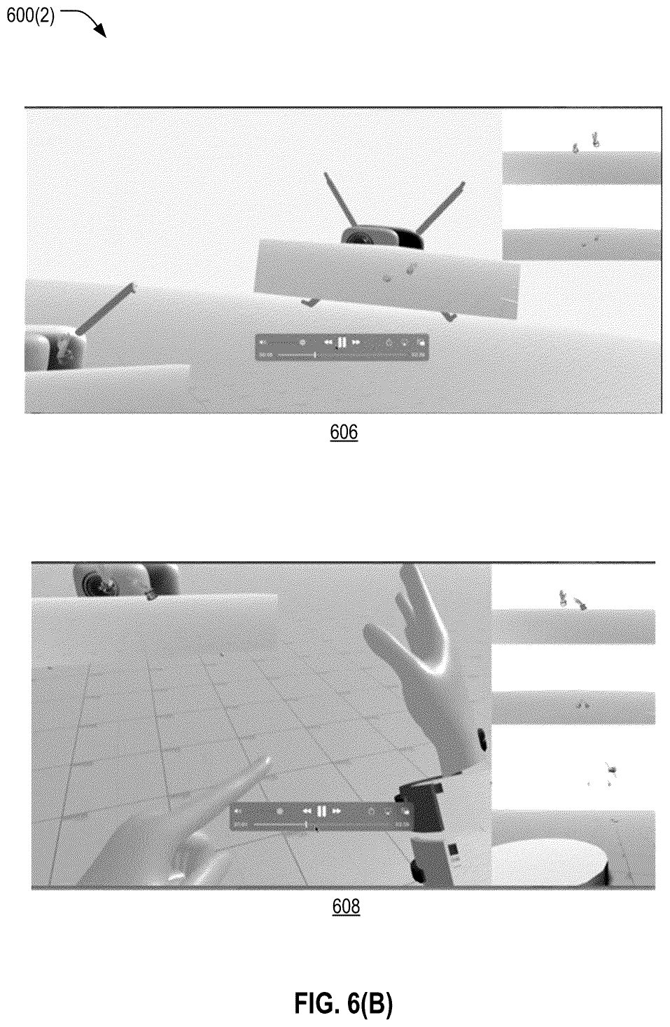

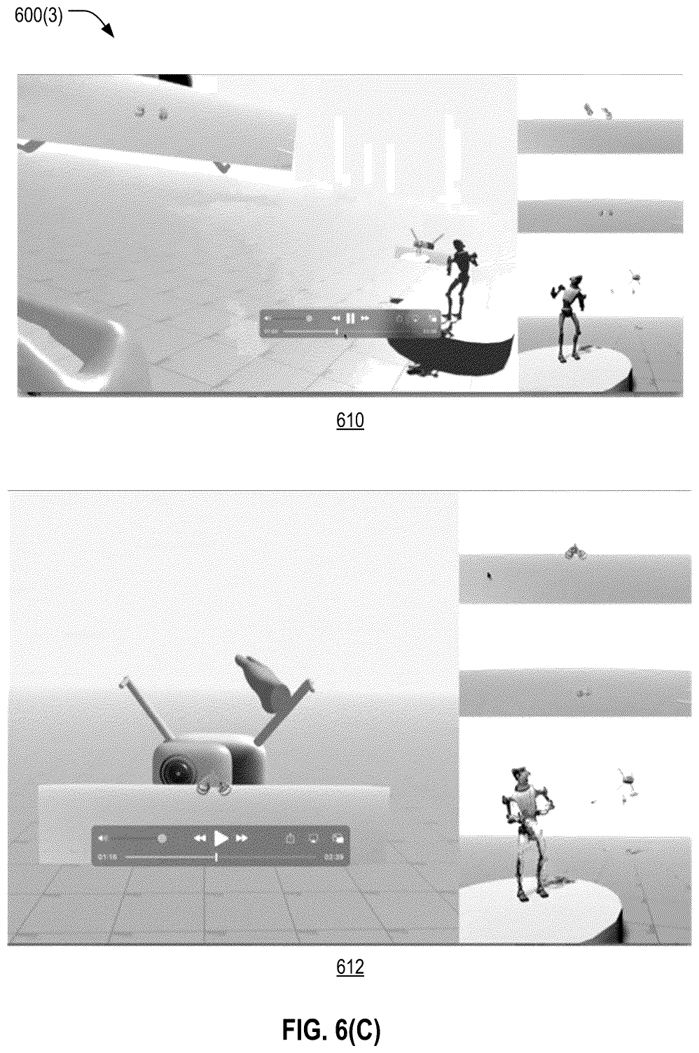

FIG. 6(A), FIG. 6(B), and FIG. 6(C) illustrate an example use of the technology described herein to control a graphical representations of a camera clone, in an extended reality (ER) environment.

FIG. 6(A) at 600(1), presents a series of images representing screen captures of recordings of prototypes of the technology described herein in use.

Image 602 illustrates an example of a graphical representation of a camera clone in an ER environment providing a heads-up display and picture-in-picture view of a representation of power gloves in use. In some examples, the illustrated operation can be associated with a different type of glove than a power glove, a wrist band, a virtual representation of a button associated with an ER headset, etc.

Image 604 illustrates an example of a graphical representation of a second camera clone being created via a button push on the left power glove in the ER environment, the first camera clone providing a heads-up display and picture-in-picture view of the power gloves in use, and the second camera clone providing a second picture-in-picture view of the power gloves in use from a different perspective. In various examples, the button can be a part of or associated with a different type of glove than a power glove, a wrist band, a virtual representation of a button associated with an ER headset, etc.

FIG. 6(B) at 600(2), presents a series of images representing screen captures of recordings of prototypes of the technology described herein in use. For example, series 600(2) can represent additional images from a session including the series 600(1).

Image 606 illustrates a view capturing a graphical representation of both camera clones, copies, or instances, the second camera clone's heads-up display, and the picture-in-picture views of the power gloves in use from both perspectives.

Image 608 illustrates a view capturing a graphical representation of the first camera clone, the first camera clone's heads-up display, the picture-in-picture views of the power gloves in use from the perspectives of both of the first camera clone and the second camera clone, and a picture-in-picture view of a third perspective of the ER environment including the first and second camera clones, copies, or instances, and the hands from the perspective of a third camera clone.

FIG. 6(C) at 600(3), presents a series of images representing screen captures of recordings of prototypes of the technology described herein in use. For example, series 600(3) can represent additional images from a session including the series 600(1) and/or the series 600(2).

Image 610 illustrates a view capturing a graphical representation of the first camera clone, the first camera clone's heads-up display, the third camera clone, the third camera clone's heads-up display, and a body clone of the user, the picture-in-picture views of the power gloves in use from the perspectives of both of the first camera clone and the second camera clone, and a picture-in-picture view of a third perspective of the ER environment including the body clone, the first and second camera clones, copies, or instances, and the hands from the perspective of the third camera clone.

Image 612 illustrates a view capturing a graphical representation of the first camera clone, the first camera clone's heads-up display, a clone of the user's right hand, the picture-in-picture views of the power gloves in use from the perspectives of both of the first camera clone and the second camera clone, and a picture-in-picture view of a third perspective of the ER environment including the body clone, the first and second camera clones, copies, or instances, the hands, and the cloned hand from the perspective of the third camera clone.

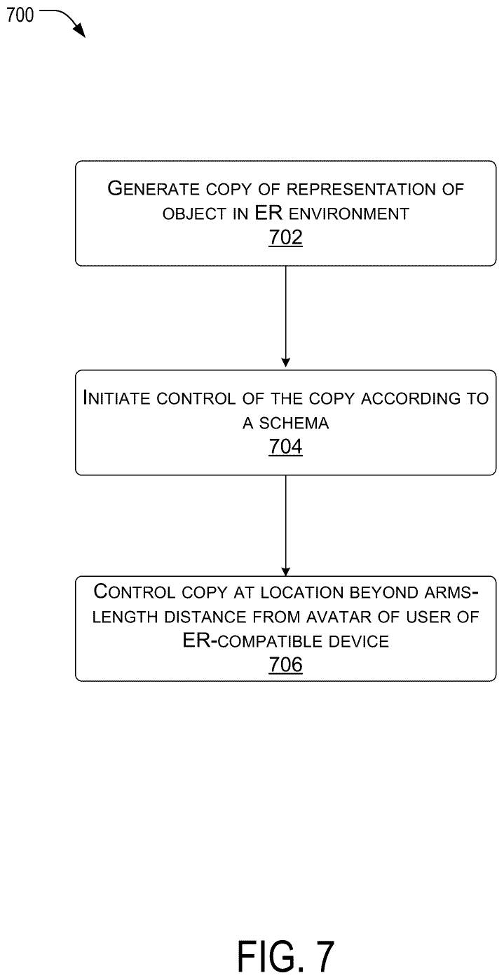

FIG. 7 is a flowchart illustrating an example process 700 employing the technology described herein.

Block 702 represents generating, e.g., via an extended-reality-compatible device, a copy of a representation of an object in an extended-reality (ER) environment.

Block 704 represents initiating control of the copy of the representation of the object according to a schema.

Block 706 represents controlling the copy of the representation of the object at a first location in the extended-reality environment. In some examples, the first location can include a location beyond-arm's-length distance from a second location in the extended-reality environment. The second location can include a location of a representation of a user, e.g., an avatar of a user, and/or a representation of a control associated with the user of the extended-reality-compatible device, e.g., an I/O interface, e.g., a wearable device, such as a head-mounted display (e.g., headset, glasses, helmet, visor, etc.), a suit, gloves, a watch, or any combination of these, a handheld computing device (e.g., tablet, phone, handheld gaming device, etc.), a portable computing device (e.g., laptop), or a stationary computing device (e.g., desktop computer, television, set top box, a vehicle computing device).

Although the discussion above sets forth examples of the described techniques and technology, other architectures can be used to implement the described functionality and are intended to be within the scope of this disclosure. Furthermore, although the subject matter has been described in language specific to structural features and/or methodological acts, it is to be understood that the subject matter defined in associated claims is not necessarily limited to the specific features or acts described. Rather, the specific features and acts are disclosed as example forms of implementing the claims.

### EXAMPLE CLAUSES

Clause 1: A method comprising: generating, via an extended-reality-compatible device, a copy of a representation of an object in an extended-reality (ER) environment; initiating control of the copy of the representation of the object according to a schema; and controlling the copy of the representation of the object at a first location in the extended-reality environment, the first location including a location beyond-arm's-length distance from a second location in the extended-reality environment, the second location being a location of an avatar of a user of the extended-reality-compatible device.

Clause 2: A method as clause 1 recites, wherein the copy of the representation of the object comprises at least one of a copy of a graphical representation of a hand, a copy of graphical representation of another part of a user's body, and/or a copy of a graphical representation of a camera.

Clause 3: A method as clause 1 or 2 recites, wherein the copy of the representation of the object includes a first copy of the representation of the object, and the method further comprises generating a plurality of clones, copies, or instances of the representation of the object including the first copy.

Clause 4: A method as any of the previous clauses recite, wherein the copy of the representation of the object includes a copy of a graphical representation of a first object, and the method further comprises generating clones, copies, or instances of a plurality of graphical representations of objects including the graphical representation of the first object.

Clause 5: A method as clauses 3 and/or 4 recite, further comprising configuring the clones, copies, or instances in an array.

Clause 6: A method as any of clauses 3-5 recite, further comprising receiving input to manipulate a representation of an object other than the representation of the object corresponding to the copy of the representation of the object to perform at least a part of the controlling of the representation of the object, wherein the representation of the object can include a graphical representation of the object.

Clause 7: A method as any of clauses 3-6 recite, wherein the controlling includes controlling the clones, copies, or instances at least one of individually, separately, in unison, independently, and/or in tandem.

Clause 8: A method as any of the previous clauses recite, wherein the generating can occur at the second location or another location, which can include the first location.

Clause 9: A method as clauses 1-7 or clause 8 recites, wherein the generating occurs at a location other than the first location, the method further comprising moving the copy of the representation of the object to the first location.

Clause 10: A method as any of the previous clauses recite, further comprising maintaining the copy of the representation of the object at the first location.

Clause 11: A method as clause 10 recites, wherein the maintaining includes keeping the copy of the representation of the object in an inactive state at the first location until receiving input to activate or reactivate the copy of the representation of the object via the extended-reality-compatible device.

Clause 116: A method as any of the previous clauses recite, further comprising controlling the copy or copies to interact with an item in the first location.

Clause 13: A method as clause 116 recites, wherein the interaction includes at least one of the copy or copies picking up an item and moving the item.

Clause 14: A method as clauses 116 and/or 13 recite, wherein the interaction includes at least one of the copy or copies holding a writing instrument and writing on a surface.

Clause 15: A method as clause 13 recites, wherein the moving the item includes removing the item from the first location, presenting the item at another location, wherein the another location can include the second location.

Clause 16: A computer-readable medium having processor-executable instructions thereon, which, upon execution configure the extended-reality-compatible device to perform a method as any of the previous clauses recite.

Clause 17: An extended-reality system comprising: a processor; and a computer-readable medium as clause 16 recites.

Clause 18: The extended-reality-compatible device of clause 1 comprising: a processor; and a computer-readable medium having processor-executable instructions thereon, which, upon execution by the processor configure the extended-reality-compatible device to perform a method as any of clauses 1-15 recite.

We claim:

1. A method comprising:
generating, via an extended-reality-compatible device, a copy of a representation of an object in an extended-reality environment;
initiating control of the copy of the representation of the object according to a schema; and
controlling the copy of the representation of the object at a first location in the extended-reality environment, the first location including a location beyond-arm's-length distance from a second location in the extended-reality environment, the second location being a location of an avatar of a user of the extended-reality-compatible device.

2. A method as claim 1 recites, wherein the copy of the representation of the object comprises at least one of a copy of a graphical representation of a hand, a copy of a graphical representation of at least a part of a user's body, and/or a copy of a graphical representation of a camera.

3. A method as claim 1 recites, wherein the copy of the representation of the object includes a first copy of the representation of the object, and the method further comprises generating a plurality of clones, copies, or instances of the representation of the object including the first copy.

4. A method as claim 3 recites, further comprising configuring the clones, copies, or instances in an array.

5. A method as claim 3 recites, further comprising receiving input to manipulate a representation of an object other than the representation of the object corresponding to the copy of the representation of the object to perform at least a part of the controlling of the representation of the object, wherein the representation of the object can include a graphical representation of the object.

6. A method as claim 3 recites, wherein the controlling includes controlling the clones, copies, or instances at least one of individually, separately, in unison, independently, and/or in tandem.

7. A method as claim 1 recites, wherein the copy of the representation of the object includes a copy of a graphical representation of a first object, and the method further comprises generating clones, copies, or instances of a plurality of graphical representations of objects including the graphical representation of the first object.

8. A method as claim 7 recites, further comprising configuring the clones, copies, or instances in an array.

9. A method as claim 1 recites, wherein the generating can occur at the second location or another location, which can include the first location.

10. A method as claim 1 recites, wherein the generating occurs at a location other than the first location, the method further comprising moving the copy of the representation of the object to the first location.

11. A method as claim 1 recites, further comprising maintaining the copy of the representation of the object at the first location.

12. A method as claim 11 recites, wherein the maintaining includes keeping the copy of the representation of the object in an inactive state at the first location until receiving input to activate or reactivate the copy of the representation of the object via the extended-reality-compatible device.

13. A method as claim 1 recites, further comprising controlling the copy or copies to interact with an item in the first location.

14. A method as claim 13 recites, further comprising moving the item, wherein the moving the item includes removing the item from the first location, presenting the item at another location, wherein the another location can include the second location.

15. A method as claim 13, wherein the interaction includes at least one of the copy or copies holding a writing instrument and writing on a surface.

16. A method as claim 13 recites, wherein the interaction includes at least one of the copy or copies picking up an item and moving the item.

17. A method as claim 16, wherein the interaction includes at least one of the copy or copies holding a writing instrument and writing on a surface.

18. A method as claim 16 recites, wherein the moving the item includes removing the item from the first location, presenting the item at another location, wherein the another location can include the second location.

19. A computer-readable medium having processor-executable instructions thereon, which, upon execution, configure an extended-reality-compatible device to perform operations comprising:
generating, via the extended-reality-compatible device, a copy of a representation of an object in an extended-reality environment;
initiating control of the copy of the representation of the object according to a schema; and
controlling the copy of the representation of the object at a first location in the extended-reality environment, the first location including a location beyond-arm's-length distance from a second location in the extended-reality environment, the second location being a location of an avatar of a user of the extended-reality-compatible device.

20. An extended-reality device-compatible comprising:
a processor; and
a computer-readable medium coupled to the processor and having processor-executable instructions thereon, which, upon execution, configure the extended-reality-compatible device to:
generate, via the extended-reality-compatible device, a copy of a representation of an object in an extended-reality environment;
initiate control of the copy of the representation of the object according to a schema; and
control the copy of the representation of the object at a first location in the extended-reality environment, the first location including a location beyond-arm's-length distance from a second location in the extended-reality environment, the second location being a location of an avatar of a user of the extended-reality-compatible device.
